(19) United States
(12) Patent Application Publication
(10) Pub. No.: US 2016/0204996 A1
(43) Pub. Date: Jul. 14, 2016

(54) SUBSCRIBER TRACING IN COMMUNICATIONS

(71) Applicant: NOKIA SOLUTIONS AND NETWORKS OY, Espoo (FI)

(72) Inventors: Tommy Johannes LINDGREN, Espoo (FI); Jani Olavi SODERLUND, Vantaa (FI); Sumanta SAHA, Espoo (FI); Niko Markus SAVOLAINEN, Kerava (FI)

(21) Appl. No.: 14/913,755

(22) PCT Filed: Aug. 13, 2014
(86) PCT No.: PCT/EP2014/067345

§ 371 Date: Feb. 23, 2016

(30) Foreign Application Priority Data
Aug. 23, 2013 (FI) 20135856

(51) Int. Cl. H04L 12/26

(52) U.S. Cl. CPC H04L 43/022; H04L 43/04; H04L 43/12

(57) ABSTRACT

A method is disclosed for subscriber tracing in a communications system. The method comprises receiving, in a gateway apparatus (GGSN, PGW) from an O&M unit, a command message for triggering a subscriber tracing functionality. The gateway apparatus (GGSN, PGW) instructs a network node to clone each packet having a certain IP address or TEID value, in order the network node to replicate each user plane packet belonging to a session to be monitored and to send the replicated packets directly to the O&M unit for further analysis. The gateway apparatus (GGSN, PGW) collects control plane data related to the session to be monitored, and transmits the collected control plane data directly to the O&M unit in order the collected control plane data to be correlated in the O&M unit to user plane data.

### FIELD OF THE INVENTION

The exemplary and non-limiting embodiments of this invention relate generally to wireless communications networks, and more particularly to subscriber tracing.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

OpenFlow is a communications protocol providing access to a forwarding plane of a network switch or router over the network. OpenFlow is a standard communications interface defined between the control and forwarding layers of the SDN architecture. OpenFlow provides direct access to a forwarding plane of network devices such as switches and routers, both physical and virtual. Open networking foundation (ONF) is an organization for promoting and adopting software-defined networking (SDN).

A virtual machine (VM) is a simulation of a computer and its associated devices by another computer system. A virtual machine may be based on a software implementation of a computer that executes programs like a physical machine.

EP 2 219 323 A1 discloses a method for analysing data transferred in a communications network. The analysis of the user plane and the control plane is done separately in a user plane analysis appliance. The separate analysis is then combined by certain criteria and the combined data is shown.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, apparatuses, and a computer program product as defined in the independent claims. Further embodiments of the invention are disclosed in the dependent claims.

An aspect of the invention relates to a method for subscriber tracing in a communications system, the method comprising receiving, in a gateway apparatus from an O&M unit, a command message for triggering a subscriber tracing functionality; instructing a network node to clone each packet having a certain IP address or TEID value, in order the network node to replicate each user plane packet belonging to a session to be monitored and to send the replicated packets directly to the O&M unit for further analysis; collecting, in the gateway apparatus, control plane data related to the session to be monitored; transmitting the collected control plane data directly from the gateway apparatus to the O&M unit in order the collected control plane data to be correlated in the O&M unit to user plane data.

A further aspect of the invention relates to a method for subscriber tracing in a communications system, the method comprising receiving, in a second apparatus from a gateway apparatus, instructions to clone each packet having a certain IP address or TEID value; based on the received instructions, replicating each user plane packet belonging to a session to be monitored; sending the replicated packets directly from the second apparatus to the O&M unit for further analysis.

A still further aspect of the invention relates to a method for subscriber tracing in a communications system, the method comprising transmitting a command message from a third apparatus to a gateway apparatus, for triggering a subscriber tracing functionality; receiving, in the third apparatus from a network node, replicated user plane packets belonging to the session to be monitored in order to perform further analysis; receiving, in the third apparatus from the gateway apparatus, collected control plane data related to the session to be monitored; correlating, in the third apparatus, the control plane data to user plane data to perform an analysis on said data.

A still further aspect of the invention relates to a first apparatus comprising at least one processor; and at least one memory including a computer program code, wherein the at least one memory and the computer program code are configured to, with the at least one processor, cause the first apparatus to perform any of the method steps.

A still further aspect of the invention relates to a second apparatus comprising at least one processor; and at least one memory including a computer program code, wherein the at least one memory and the computer program code are configured to, with the at least one processor, cause the second apparatus to receive, from a gateway apparatus, instructions to clone each packet having a certain IP address or TEID value; based on the received instructions, replicate each user plane packet belonging to a session to be monitored; send the replicated packets directly to the O&M unit for further analysis.

A still further aspect of the invention relates to a third apparatus comprising at least one processor; and at least one memory including a computer program code, wherein the at least one memory and the computer program code are configured to, with the at least one processor, cause the third apparatus to transmit a command message to a gateway apparatus, for triggering a subscriber tracing functionality; receive, from a network node, replicated user plane packets belonging to the session to be monitored in order to perform further analysis; receive, from the gateway apparatus, collected control plane data related to the session to be monitored; correlate the control plane data to user plane data to perform an analysis on said data.

A still further aspect of the invention relates to a computer program product comprising program instructions which, when run on a computing apparatus, causes the computing apparatus to perform any of the method steps.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 illustrates a 3GPP network architecture;

FIG. 2 illustrates an existing solution for subscriber tracing;

FIG. 3 illustrates gateways running in virtual machines;

FIG. 4 illustrates packet cloning according to an exemplary embodiment;

FIG. 5 shows a simplified block diagram illustrating exemplary apparatuses;

FIG. 6 shows a messaging diagram illustrating an exemplary messaging event according to an embodiment of the invention;

FIG. 7 shows a schematic diagram of a flow chart according to an exemplary embodiment of the invention;

FIG. 8 shows a schematic diagram of a flow chart according to an exemplary embodiment of the invention;

FIG. 9 shows a schematic diagram of a flow chart according to an exemplary embodiment of the invention.

### DETAILED DESCRIPTION OF SOME EMBODIMENTS

In a mobile network, user sessions are established as tunnels between mobile terminals (MT) and gateways (GW). Due to the cellular network architecture, gateways are aggregation points for the user sessions, providing an anchor towards services in the internet or operator service network. In 3G, the gateway is a GGSN element, and in LTE, a SAE-GW element.

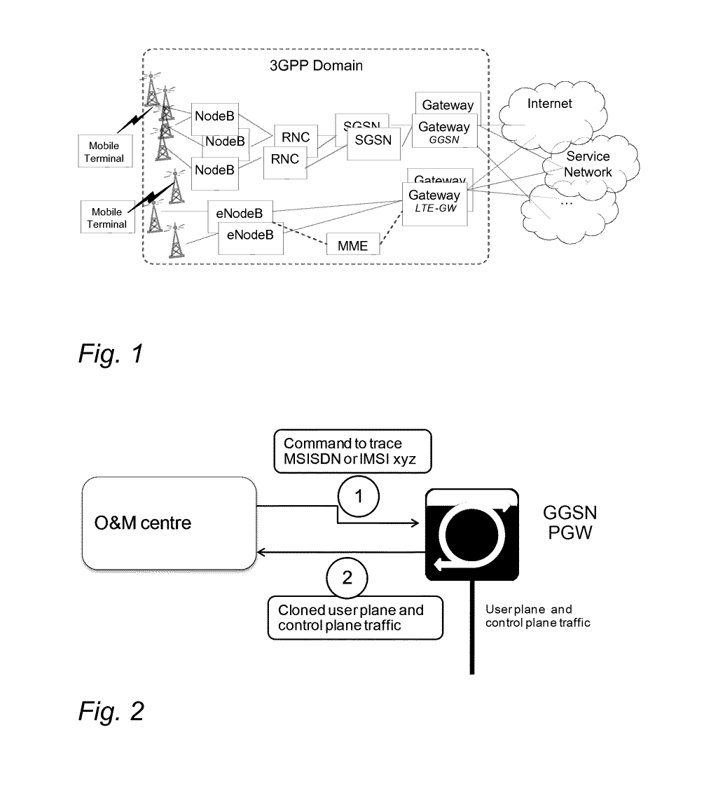

FIG. 1 illustrates a 3GPP network. The number of gateway elements in an operator network ranges from a minimum of two (2) to up to twenty (20), depending on the size of the operator's subscriber base, redundancy requirements, site strategy, element capacity, and so forth. As the market demands higher aggregation capabilities, only few elements are expected to stay in the network. The user sessions are distributed across the gateway elements.

Subscriber tracing is supported in many network elements especially for problem solution and debugging purposes. Typically subscriber trace functionality captures and stores all signalling and user plane payload traffic which is then sent/downloaded to a network operation and maintenance centre for further analysis with e.g. decoding tools. FIG. 2 illustrates an existing solution for subscriber tracing.

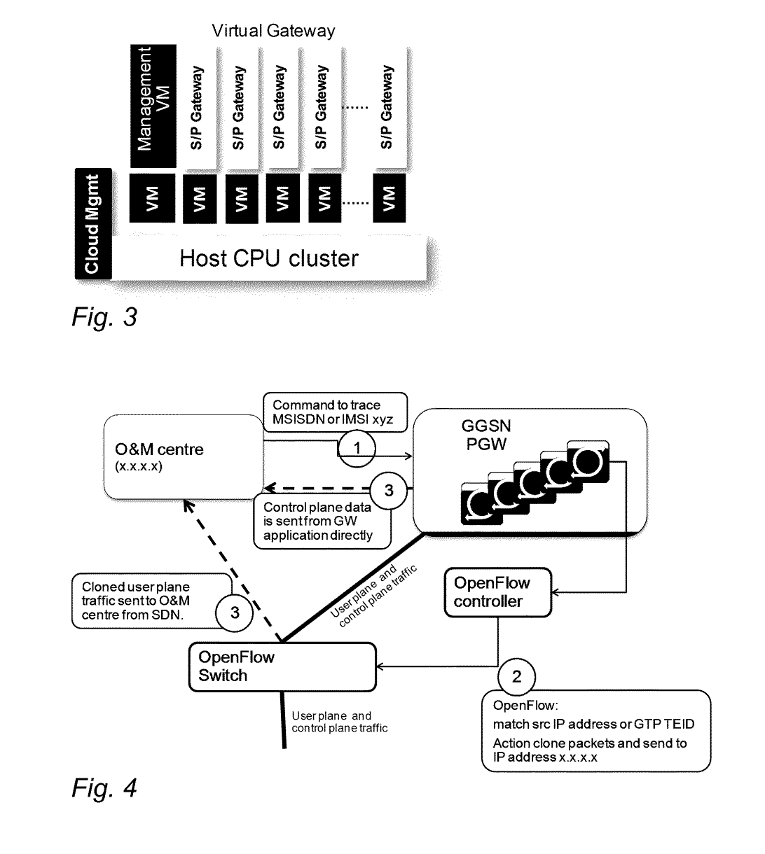

Existing EPC gateways (S-GW, P-GW) are built as stand-alone network elements using dedicated hardware. In the future, also a mobile gateway is likely to be implemented as a software only solution running over generic hardware that may be virtualized. To address gateway user plane requirements it is possible that also a SDN based solution is used in combination with the virtualized hardware. FIG. 3 illustrates an exemplary gateway running in virtual machines over generic hardware.

Subscriber tracing is typically a very resource intensive functionality and may impact network element performance. Problem solving usually requires detailed information from e.g. used tunneling headers from each relevant interface, which requires several copies of each packet to be sent for post analyses. Typically only a very limited amount of concurrent traces is allowed in a system (e.g. 50 in a single gateway).

In a cloud based solution the performance is expected to be lower than in a bare metal solution (due to virtualization overhead and the need to use x86 architecture) and in EPC the data rates are so high that the trace functionality may overload the computing resources unexpectedly. Therefore, with a virtualized product, it may be problematic to implement subscriber trace functionality in the same fashion as part of application software. For example, it is expected that a single virtual machine (VM) is able to process user plane traffic at 1 gigabit per second, whereas a single active user's traffic may be 100 Mbps which is 10% of the whole virtual machine's capacity.

Subscriber trace may be implemented as a product internal functionality by capturing either signalling traffic or both signalling and user plane traffic. Data is either sent immediately to the network operation and maintenance centre (O&M), or the data is stored on local storage (hard disk) and then downloaded from there by operator O&M personnel. Another solution is to use external probes for monitoring and capturing traffic. Data from probes is similarly analysed by the operator O&M personnel.

An exemplary embodiment involves subscriber trace triggering with OpenFlow. An exemplary embodiment proposes to implement the subscriber trace capturing functionality in an SDN switch (such as an OpenFlow switch) instead of implementing the functionality in an application within the cloud. The triggering of the subscriber trace functionality may be implemented by matching a packet either by an IP address, a GTP tunnel endpoint identifier (TEID), a GRE key, or an L2TP session and tunnel identification. End user packets may be cloned in both directions and in each relevant interface. The SDN switch replicates packets and sends them out from an O&M interface.

The gateway (GW) knows UE related identifications in each relevant interface: GTP-U TEID in an S4/S1U/S5 interface, the GRE key in an S2/S5/S8 interface, UE IP addresses inside GRE tunnels in an Gi/SGi interface, an L2TP session and tunnel identification in the SGi interface, and the IP address in the Gi/SGi interface. The UE identification may be used to trigger tracing by using OpenFlow.

The operation and maintenance personnel trigger the tracing functionality to the gateway in a similar fashion as with the existing gateway (e.g. via CLI commands, via a graphical user interface, via 3GPP trace activation, and/or any other mechanism suitable for the configuration). The gateway application knows the exact location of the session to be monitored/captured, and the gateway also knows the related session's identifications (e.g. a TEID value). The gateway then instructs SDN e.g. by using OpenFlow to clone each packet having a certain IP address or TEID value. The Openflow switch may be instructed to clone UE packets with each relevant identifier, thus resulting in copies of packets from both directions in each interface.

The gateway may provide an additional instruction to the OpenFlow switch on how to deliver a cloned packet. This way subscriber traces for different end users may be distributed to several servers (VMs) in the operation and maintenance centre.

Based on the gateway's instructions, the SDN switch then replicates each user plane packet belonging to the session to be monitored and sends these packets directly to O&M for further analysis via a dedicated port in the SDN switch or by using encapsulation (e.g. GRE or VLAN). Control plane data related to the monitored session is collected at the gateway application instance running in the virtual machine by copying and storing session-related signalling messages to a memory and/or a hard disk. This control plane data is sent directly from the gateway application to the O&M centre where it is to be correlated to the user plane data e.g. by using the IP address or TEID as a key.

As the tracing is terminated, the gateway application removes a trace entry from the SDN switch. FIG. 4 illustrates an exemplary embodiment with a OpenFlow switch performing packet cloning as instructed by the gateway application using Open Flow.

An exemplary embodiment enables offloading processing from the gateway application to SDN and saving computing resources in VMs. Additionally, an exemplary embodiment may be used generally for debugging and monitoring of any user plane traffic (not limited to the mobile gateway).

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support subscriber tracing. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (or LTE-A) (long term evolution (advanced long term evolution)) network elements, without restricting the embodiment to such an architecture, however. The embodiments described in these examples are not limited to the LTE radio systems but can also be implemented in other radio systems, such as 3G, 4G, 5G, B4G, UMTS (universal mobile telecommunications system), GSM, EDGE, WCDMA, bluetooth network, WLAN, WiMAX or other fixed, mobile or wireless network. In an embodiment, the presented solution may be applied between elements belonging to different but compatible systems such as LTE and UMTS.

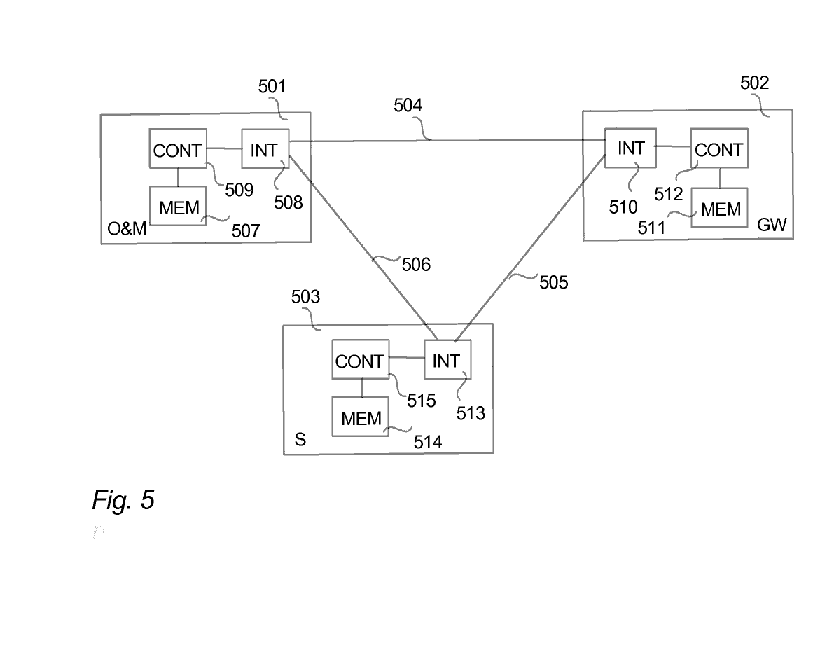

A general architecture of a communication system is illustrated in FIG. 5. FIG. 5 is a simplified system architecture only showing some elements and functional entities, all being logical units whose implementation may differ from what is shown. The connections shown in FIG. 5 are logical connections; the actual physical connections may be different. It is apparent to a person skilled in the art that the systems also comprise other functions and structures. It should be appreciated that the functions, structures, elements and the protocols used in or for subscriber tracing, are irrelevant to the actual invention. Therefore, they need not to be discussed in more detail here.

The exemplary radio system of FIG. 5 comprises a network node 501 of a network operator. The network node 501 may include e.g. an operation and maintenance centre O&M 501, or any other network element, or a combination of network elements. The network node 501 may be connected to one or more core network (CN) elements 502 such as a gateway GPRS support node (GGSN), PDN gateway (PGW). FIG. 5 shows one or more OpenFlow switches S 503 connected to the network node 501, 502. In the example situation of FIG. 5, the OpenFlow switch S 503 is capable of connecting to the network node 501, 502 via a connection 506, 505, respectively, and the network node 501 is capable of connecting to the network element 502 via a connection 504.

The operation and maintenance centre or O&M 501 comprises a controller 509 operationally connected to a memory 507 and an interface 508. The controller 509 controls the operation of the operation and maintenance centre 501. The memory 507 is configured to store software and data. The network node 501 may also comprise various other components. They are not displayed in the figure due to simplicity. The network node 501 may be operationally connected (directly or indirectly) to another network element 502, 503 of the communication system, such as a PDN gateway (PGW), a gateway GPRS support node, OpenFlow switch, via the interface 508. The network node or GGSN 502 (or PGW 502) comprises a controller 512 operationally connected to a memory 511 and an interface 510. The controller 512 controls the operation of the gateway node 502. The memory 511 is configured to store software and data. The network node 502 may also comprise various other components. They are not displayed in the figure due to simplicity. The network node 502 may be operationally connected (directly or indirectly) to another network element 501, 503 of the communication system, such as a PDN gateway (PGW), a gateway GPRS support node, OpenFlow switch, via the interface 510. The OpenFlow switch or S 503 comprises a controller 515 operationally connected to a memory 514 and an interface 513. The controller 515 controls the operation of the switch 503. The memory 514 is configured to store software and data. The switch 503 may also comprise various other components. They are not displayed in the figure due to simplicity. The switch may be operationally connected (directly or indirectly) to another network element 501, 502 of the communication system, such as an operation and maintenance centre O&M 501, a PDN gateway (PGW), a gateway GPRS support node, via the interface 513. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 501, 502, 503 has been depicted as one entity, different modules and memory may be implemented in one or more physical or logical entities. The apparatus may be an operation and maintenance centre (O&M), a gateway GPRS support node (GGSN), a PDN gateway (PGW), a switch, a radio network controller (RNC), a mobility management entity (MME), an MSC server (MSS), a mobile switching centre (MSC), a radio resource management (RRM) node, an operations, administrations and maintenance (OAM) node, a home location register (HLR), a visitor location register (VLR), a serving GPRS support node, a base station, an access point, a gateway, and/or a server, The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, a tablet, and a line telephone.

The apparatus 501, 502, 503 may generally include a processor, controller, control unit or the like connected to a memory and to various inter-faces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 507, 511, 514 may include volatile and/or non-volatile memory and typically stores content, data, or the like. For example, the memory 507, 511, 514 may store computer program code such as software applications (for example for the detector unit and/or for the adjuster unit) or operating systems, information, data, content, or the like for a processor to per-form steps associated with operation of the apparatus 501, 502, 503 in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

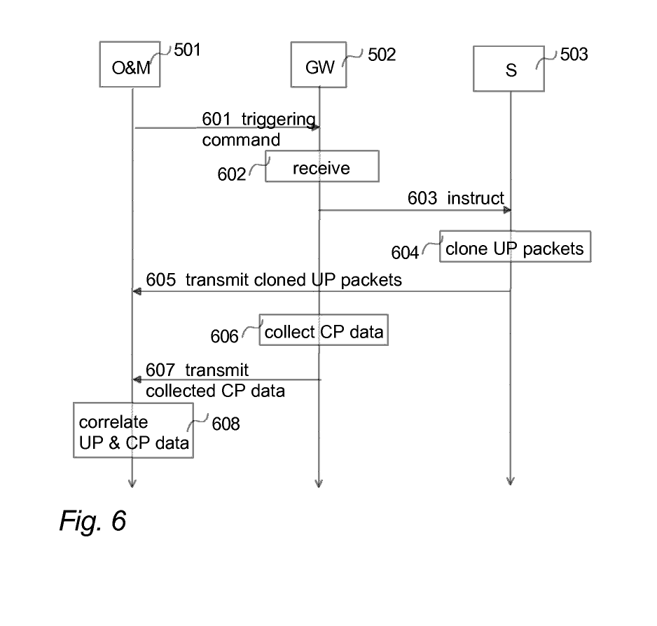

The signalling chart of FIG. 6 illustrates the required signalling. FIG. 6 illustrates exemplary packet cloning/subscriber tracing. In the example of FIG. 6, a core network node 501, e.g. O&M unit (such as an operation and maintenance centre O&M), may be configured to transmit a command message 601 to a network node 502, e.g. a gateway apparatus (such as a gateway GPRS support node GGSN or a PDN gateway PGW), for triggering a subscriber tracing functionality. In item 602, the gateway apparatus 502 may receive the command message from the O&M unit 501 to trigger the subscriber tracing functionality. Based on the received command message, the gateway apparatus 502 may be configured to instruct 603 a network node 503, e.g. a switch (such as an OpenFlow switch), to clone each packet having a certain IP address or TEID value. In item 604, the switch 503 may receive the message 603 and based on that replicate each user plane packet belonging to a session to be monitored and send 605 the replicated packets directly to the O&M unit for further analysis. In item 606, the gateway apparatus 502 may be configured to collect control plane data related to the session to be monitored. In item 607, gateway apparatus 502 may be configured to transmit the collected control plane data directly to the O&M unit (501). In item 608, the O&M unit may receive the collected control plane data and correlate the control plane data to user plane data for further analysis (such as fault debugging). The correlating enables providing a full view on the subscriber activity in a particular network element.

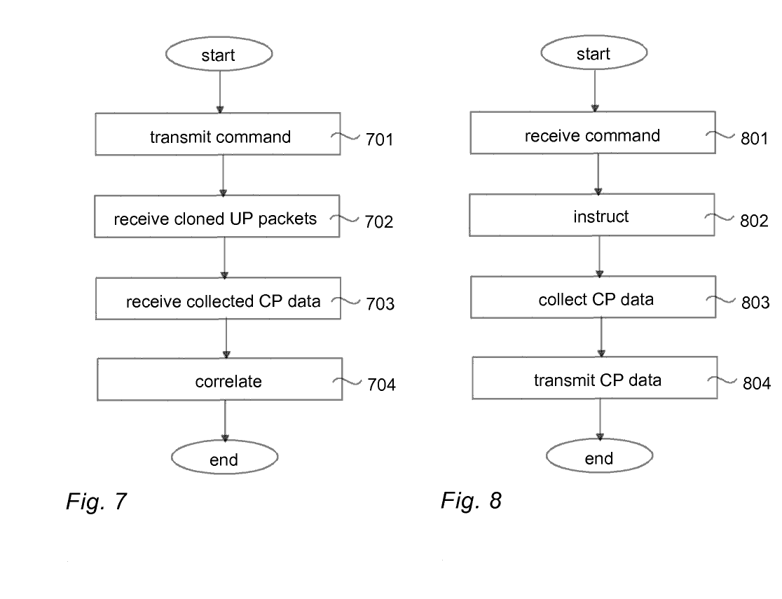

FIG. 7 is a flow chart illustrating an exemplary embodiment. An apparatus 501, e.g. O&M unit (such as an operation and maintenance centre O&M), may be configured to transmit 701 a command message to a network node 502, e.g. a gateway apparatus (such as a gateway GPRS support node GGSN or a PDN gateway PGW), for triggering a subscriber tracing functionality. In item 702, the O&M unit 501 may receive replicated user plane packets belonging to the session to be monitored from the switch 503 in order to perform further analysis. In item 703, the O&M unit may receive collected control plane data related to the session to be monitored from the gateway apparatus 502. In item 704, the O&M unit may correlate the control plane data to user plane data for further analysis such as fault debugging. The correlating enables providing a full view on the subscriber activity in a particular network element.

FIG. 8 is a flow chart illustrating an exemplary embodiment. An apparatus, e.g. a gateway apparatus 502 (such as a gateway GPRS support node GGSN or a PDN gateway PGW), may be configured to receive 801 a command message from a network node 501, e.g. O&M unit (such as an operation and maintenance centre O&M), for triggering a subscriber tracing functionality. In item 802, based on the received command message, the gateway apparatus 502 may be configured to instruct a network node 503, e.g. a switch (such as an OpenFlow switch), to clone each packet having a certain IP address or TEID value. In item 803, the gateway apparatus 502 may be configured to collect control plane data related to the session to be monitored session. In item 804, gateway apparatus 502 may be configured to transmit the collected control plane data directly to the O&M unit 501 in order the control plane data to be correlated to user plane data for further analysis such as fault debugging. The correlating enables providing a full view on the subscriber activity in a particular network element.

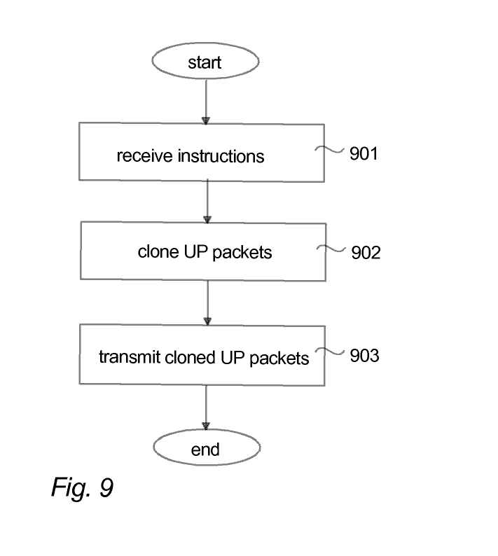

FIG. 9 is a flow chart illustrating an exemplary embodiment. An apparatus 503, e.g. a switch (such as an OpenFlow switch), may be configured to receive 901 instructions from a gateway apparatus 502, e.g. GGSN, PGW, to clone each packet having a certain IP address or TEID value. In item 902, the switch 503 may replicate each user plane packet belonging to a session to be monitored. In item 903, the switch 503 may send the replicated packets directly to the O&M unit for further analysis.

An exemplary embodiment enables filtering user plane data in a collector (an SDN device, e.g. an SDN based user plane unit (such as an OpenFlow switch in the data path of the user plane traffic)) using GTP TEID and/or UE IP address. The SDN device in the network performs pre-filtering and only sends a fraction of the user plane traffic to an analyzer (e.g. an O&M unit). An exemplary embodiment enables selectively capturing traffic of a certain subscriber (based on GTP TEID and/or UE IP address). Filters may be dynamically configured on-need basis by a controlling device (e.g. a gateway), so that only those packets which the operator really wants to be captured are sent to the analyzer. An exemplary embodiment is not limited to the S1 interface.

The steps/points, signalling messages and related functions described above in FIGS. 1 to 9 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

Thus, according to an exemplary embodiment, there is provided a method for subscriber tracing in a communications system, the method comprising receiving, in a gateway apparatus from an O&M unit, a command message for triggering a subscriber tracing functionality; instructing a network node to clone each packet having a certain IP address or TEID value, in order the network node to replicate each user plane packet belonging to a session to be monitored and to send the replicated packets directly to the O&M unit for further analysis; collecting, in the gateway apparatus, control plane data related to the session to be monitored; transmitting the collected control plane data directly from the gateway apparatus to the O&M unit in order the collected control plane data to be correlated in the O&M unit to user plane data.

According to another exemplary embodiment, the triggering of the subscriber tracing functionality is carried out via a CLI command and/or via a graphical user interface.

According to another exemplary embodiment, the method comprises using a user terminal related identification to trigger the subscriber tracing functionality by using an SDN switch.

According to yet another exemplary embodiment, the SDN switch comprises an OpenFlow switch.

According to yet another exemplary embodiment, the method comprises maintaining, in the gateway apparatus, information on an exact location of the session to be monitored, and information on a related session identification.

According to yet another exemplary embodiment, the method comprises instructing the network node to clone user plane packets with each relevant identifier, to produce copies of packets from both directions in each interface.

According to yet another exemplary embodiment, the method comprises providing an additional instruction to the network node on how to deliver a cloned packet in order to distribute subscriber traces for different end users to several virtual machines in the O&M unit.

According to yet another exemplary embodiment, the method comprises sending the replicated packets directly to the O&M unit for further analysis via a dedicated port in the network node and/or by using encapsulation.

According to yet another exemplary embodiment, the collected control plane data is correlated to the user plane data by using an IP address and/or TEID as a key.

According to yet another exemplary embodiment, as the tracing is terminated, the subscriber trace is removed from the network node.

According to yet another exemplary embodiment, the related session identification comprises a TEID value.

According to yet another exemplary embodiment, there is provided a method for subscriber tracing in a communications system, the method comprising receiving, in a second apparatus from a gateway apparatus, instructions to clone each packet having a certain IP address or TEID value; based on the received instructions, replicating each user plane packet belonging to a session to be monitored; sending the replicated packets directly from the second apparatus to the O&M unit for further analysis.

According to yet another exemplary embodiment, there is provided a method for subscriber tracing in a communications system, the method comprising transmitting a command message from a third apparatus to a gateway apparatus, for triggering a subscriber tracing functionality; receiving, in the third apparatus from a network node, replicated user plane packets belonging to the session to be monitored in order to perform further analysis; receiving, in the third apparatus from the gateway apparatus, collected control plane data related to the session to be monitored; correlating, in the third apparatus, the control plane data to user plane data to perform an analysis on said data.

According to yet another exemplary embodiment, there is provided a first apparatus comprising at least one processor; and at least one memory including a computer program code, wherein the at least one memory and the computer program code are configured to, with the at least one processor, cause the first apparatus to perform any of the method steps.

According to yet another exemplary embodiment, there is provided a second apparatus comprising at least one processor; and at least one memory including a computer program code, wherein the at least one memory and the computer program code are configured to, with the at least one processor, cause the second apparatus to receive, from a gateway apparatus, instructions to clone each packet having a certain IP address or TEID value; based on the received instructions, replicate each user plane packet belonging to a session to be monitored; send the replicated packets directly to the O&M unit for further analysis.

According to yet another exemplary embodiment, there is provided a third apparatus comprising at least one processor; and at least one memory including a computer program code, wherein the at least one memory and the computer program code are configured to, with the at least one processor, cause the third apparatus to transmit a command message to a gateway apparatus, for triggering a subscriber tracing functionality; receive, from a network node, replicated user plane packets belonging to the session to be monitored in order to perform further analysis; receive, from the gateway apparatus, collected control plane data related to the session to be monitored; correlate the control plane data to user plane data to perform an analysis on said data.

According to yet another exemplary embodiment, there is provided a computer program product comprising program instructions which, when run on a computing apparatus, causes the computing apparatus to perform any of the method steps.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

CP control plane
GGSN gateway GPRS support node
GW gateway
LTE long term evolution
MME mobility management entity
MT mobile terminal
PGW packet data network gateway
SAE system architecture evolution
SDN software defined network
SGW serving gateway
SGSN serving GPRS support node
UP user plane
VM virtual machine
GTP GPRS tunneling protocol
GRE generic routing encapsulation
CLI command line interface

1. A method for subscriber tracing in a communications system, the method comprising:
receiving, in a gateway apparatus from an O&M unit, a command message for triggering a subscriber tracing functionality;
instructing a network node to clone each packet having a certain IP address or TEID value, in order the network node to replicate each user plane packet belonging to a session to be monitored and to send the replicated packets directly to the O&M unit for further analysis;
collecting, in the gateway apparatus, control plane data related to the session to be monitored;
transmitting the collected control plane data directly from the gateway apparatus to the O&M unit in order the collected control plane data to be correlated in the O&M unit to user plane data.

2. A method according to claim 1, wherein the triggering of the subscriber tracing functionality is carried out via a CLI command or via a graphical user interface.

3. A method as claimed in claim 1, wherein a user terminal related identification is used to trigger the subscriber tracing functionality by using an SDN switch.

4. A method as claimed in claim 3, wherein the SDN switch comprises an OpenFlow switch.

5. A method as claimed in claim 1, wherein the method comprises maintaining, in the gateway apparatus, information on an exact location of the session to be monitored, and information on a related session identification.

6. A method as claimed in claim 1, wherein the method comprises instructing the network node to clone user plane packets with each relevant identifier, to produce copies of packets from both directions in each interface.

7. A method as claimed in claim 1, wherein the method comprises providing an additional instruction to the network node on how to deliver a cloned packet in order to distribute subscriber traces for different end users to several virtual machines in the O&M unit.

8. A method as claimed in claim 1, wherein the method comprises sending the replicated packets directly to the O&M unit for further analysis via a dedicated port in the network node or by using encapsulation.

9. A method as claimed in claim 1, wherein the collected control plane data is correlated to the user plane data by using an IP address or TEID as a key.

10. A method as claimed in claim 1, wherein, as the tracing is terminated, the subscriber trace is removed from the network node.

11. A method as claimed in claim 5, wherein the related session identification comprises a TEID value.

12. A method for subscriber tracing in a communications system, the method comprising:
receiving, in a second apparatus from a gateway apparatus, instructions to clone each packet having a certain IP address or TEID value;
based on the received instructions, replicating each user plane packet belonging to a session to be monitored;
sending the replicated packets directly from the second apparatus to the O&M unit for further analysis.

13. A method for subscriber tracing in a communications system, the method comprising:
transmitting a command message from a third apparatus to a gateway apparatus, for triggering a subscriber tracing functionality;
receiving, in the third apparatus from a network node, replicated user plane packets belonging to the session to be monitored in order to perform further analysis;
receiving, in the third apparatus from the gateway apparatus, collected control plane data related to the session to be monitored;
correlating, in the third apparatus, the control plane data to user plane data to perform an analysis on said data.

14. A first apparatus comprising at least one processor; and at least one memory including a computer program code, wherein the at least one memory and the computer program code are configured to, with the at least one processor, cause the first apparatus to perform any of the following method steps:
receiving, in a gateway apparatus from an O&M unit, a command message for triggering a subscriber tracing functionality;
instructing a network node to clone each packet having a certain IP address or TEID value, in order the network node to replicate each user plane packet belonging to a session to be monitored and to send the replicated packets directly to the O&M unit for further analysis;
collecting, in the gateway apparatus, control plane data related to the session to be monitored;
transmitting the collected control plane data directly from the gateway apparatus to the O&M unit in order the collected control plane data to be correlated in the O&M unit to user plane data.

15. A second apparatus comprising at least one processor;
and at least one memory including a computer program code, wherein the at least one memory and the computer program code are configured to, with the at least one processor, cause the second apparatus to
receive, from a gateway apparatus, instructions to clone each packet having a certain IP address or TEID value;
based on the received instructions, replicate each user plane packet belonging to a session to be monitored;
send the replicated packets directly to the O&M unit for further analysis.

16. A third apparatus comprising at least one processor; and at least one memory including a computer program code, wherein the at least one memory and the computer program code are configured to, with the at least one processor, cause the third apparatus to
transmit a command message to a gateway apparatus, for triggering a subscriber tracing functionality;
receive, from a network node, replicated user plane packets belonging to the session to be monitored in order to perform further analysis;
receive, from the gateway apparatus, collected control plane data related to the session to be monitored;
correlate the control plane data to user plane data to perform an analysis on said data.

17. A computer program product embodied on a non-transitory medium that is readable by a computing apparatus, the computer program product comprising program instructions which, when run on the computing apparatus, causes the computing apparatus to perform any of the following method steps:
receiving, in a gateway apparatus from an O&M unit, a command message for triggering a subscriber tracing functionality;
instructing a network node to clone each packet having a certain IP address or TEID value, in order the network node to replicate each user plane packet belonging to a session to be monitored and to send the replicated packets directly to the O&M unit for further analysis;
collecting, in the gateway apparatus, control plane data related to the session to be monitored;
transmitting the collected control plane data directly from the gateway apparatus to the O&M unit in order the collected control plane data to be correlated in the O&M unit to user plane data.

18. A computer program product embodied on a non-transitory medium that is readable by a computing apparatus, the computer program product comprising program instructions which, when run on the computing apparatus, causes the computing apparatus to perform any of the following method steps:
receiving, in a second apparatus from a gateway apparatus, instructions to clone each packet having a certain IP address or TEID value;
based on the received instructions, replicating each user plane packet belonging to a session to be monitored;
sending the replicated packets directly from the second apparatus to the O&M unit for further analysis.

19. A computer program product embodied on a non-transitory medium that is readable by a computing apparatus, the computer program product comprising program instructions which, when run on the computing apparatus, causes the computing apparatus to perform any of the following method steps:
transmitting a command message from a third apparatus to a gateway apparatus, for triggering a subscriber tracing functionality;
receiving, in the third apparatus from a network node, replicated user plane packets belonging to the session to be monitored in order to perform further analysis;
receiving, in the third apparatus from the gateway apparatus, collected control plane data related to the session to be monitored;
correlating, in the third apparatus, the control plane data to user plane data to perform an analysis on said data.

20. The first apparatus according to claim 14 wherein a user terminal related identification is used to trigger the subscriber tracing functionality by using an SDN switch.
